(19) United States
(12) Patent Application Publication
(10) Pub. No.: US 2006/0127573 A1
(43) Pub. Date: Jun. 15, 2006

(54) Process and device for coating a finely milled solid

(76) Inventor: Gerhard Hauk, Muenchwilen (CH)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/538,827

(22) PCT Filed: Dec. 15, 2003
(86) PCT No.: PCT/EP03/14244

§ 371 Date: Dec. 12, 2005

(30) Foreign Application Priority Data
Dec. 13, 2002 (CH) 212802

(51) Int. Cl. B02C 19/06; B02C 23/18; B02C 21/00

(52) U.S. Cl. 427/212; 241/5; 241/38; 118/303

(57) ABSTRACT

The present invention relates to a process for the application of a liquid to a finely milled solid, which process is characterized in that the liquid to be applied to the finely milled solid is introduced into the milling zone of a fine milling apparatus during the milling operation or simultaneously with the introduction of the material for milling, and the fine milling is carried out in the presence of the finely divided liquid, and to a device for carrying out this process.

The present invention relates to a process for the application of liquids to finely milled solids and to a device for carrying out this process.

The processing of finely milled solids charged with liquid is widespread in many branches of industry, for example in the industrial manufacture and processing of foodstuffs, fine chemicals, pharmaceuticals or crop protection products. The application of the liquid is intended to provide the finely milled solid with particular properties which are advantageous for the intended use.

It is known to apply liquids to finely milled solids as follows: the solid is first finely milled, and the liquid that is to be applied is then applied to the solid in a mixing device in the form of a fine spray, followed by intensive mixing of the mixture thus obtained.

Using that process it is not possible to achieve a homogeneous distribution of the liquid on the solid, because lumps form during the mixing of the liquid with the finely milled solid, especially when viscous liquids are being used. The resulting mixture must therefore undergo at least one further milling process. The known process for the application of liquids to milled solids accordingly comprises the following individual steps:
milling of the solid;
application of the liquid by spraying, and mixing of the milled solid with the liquid; and
further milling and/or homogenisation of the resulting mixture, one or more further milling operations being necessary, depending on the type of liquid applied.

Not only is this process laborious, but in most cases, especially when the liquid to be applied is viscous, a homogeneous distribution of the liquid on the particles of the solid is not achieved, despite the subsequent additional milling operation.

The object of the present invention is to provide a process for the application of a liquid to a finely milled solid, which process avoids the disadvantages of the prior art process and, in a simple manner, permits the production of finely milled solids whose particles are homogeneously charged with a liquid.

According to the present invention it is proposed to achieve that object as follows: the liquid to be applied to the finely milled solid is introduced into the milling zone of a fine milling apparatus during the milling operation or simultaneously with the introduction of the material for milling, and the fine milling is carried out in the presence of the finely divided liquid.

The process according to the invention can in principle be carried out using any conventional fine milling apparatus if such an apparatus is provided with a device which enables the liquid that is to be applied to the finely milled solid to be introduced into the milling zone during the milling operation or simultaneously with the introduction of the material for milling. Especially suitable are mills, in which the material for milling is moved by a gas stream flowing through the milling zone, and which are provided with a device with which the finely divided liquid is introduced into the milling zone simultaneously with the introduction of the material for milling. Especially suitable mills are, for example, gas-jet mills or fluidised-bed counter-jet mills, in which the solid moved by the milling gas stream flowing at very high speed is comminuted in the milling zone by the action of the impact of the particles of the solid. When that type of mill is used, the excess pressure of the milling gas introduced into the milling zone is in the range of from 5 bar to 10 bar, especially from 6 bar to 7 bar. The excess pressure of the liquid introduced into a gas stream flowing through the milling zone or directly into the milling zone is likewise in the range of from 5 bar to 10 bar, especially from 6 bar to 7 bar, but the excess pressure of the liquid is in each case from 0.25 bar to 1 bar above the pressure of the milling gas.

The process according to the invention is preferably carried out at ambient temperature. The temperature may, however, also be up to 50° C., especially up to 30° C., below or above the ambient temperature, depending, for example, on the nature of the finely milled solid, on the pressure or on the temperature of the finely milled solid or of the liquid.

Gas-jet mills and fluidised-bed counter-jet mills are especially suitable for carrying out the process according to the Invention because, apart from the particles of the solid moved by the milling gas, they comprise no mechanically moved parts. As a result, mechanical ignition sources are avoided, which constitutes a considerable advantage when processing combustible mixtures.

Further suitable fine milling apparatuses are mechanical mills, such as impact mills or hammer mills, in which the material for milling is moved through the mill by means of a carrier gas and/or a mechanical feed device, such as a star wheel or a feed screw. In an impact mill, the solid is comminuted against the impact surfaces arranged in the milling zone. In a hammer mill, the solid is comminuted by rotating hammers, and gas is preferably used as the carrier medium for the material for milling. The pressure of the carrier gas is generally in the region of the ambient pressure. Depending on the type of milling apparatus, the pressure may also be up to 0.3 bar below or above the ambient pressure. The liquid is sprayed into the milling apparatus with a pressure that is above the pressure prevailing in the mill. Unitary or binary nozzles are especially suitable for spraying in the liquid. When a unitary nozzle is used, the pressure is preferably in the range of from 4 bar to 10 bar. When a binary nozzle is used, the pressure is preferably in the range of from 3 bar to 4 bar.

The process according to the invention is preferably also carried out at ambient temperature when a mechanical mill is used. However, the temperature may also be up to 50° C., especially up to 30° C., below or above the ambient temperature, depending, for example, on the nature of the finely milled solid, on the pressure or on the temperature of the finely milled solid or of the liquid.

As solids there come into consideration according to the invention all solid organic or inorganic substances in pure form or in the form of mixtures of different solids. The process according to the invention is especially advantageous in the case of mixtures of solids, such as solid ready-for-use formulations of pharmaceutical or agrochemical active ingredients or solid preparations of foodstuffs. For example, solid ready-formulated crop protection products, such as solid acaricides, fungicides, growth regulators, herbicides, insecticides or nematocides, can be charged with a liquid in order to improve their in-use properties, for example to achieve a better wetting of the plant or an improvement in the biological activity of the product or to facilitate the preparation of a spray broth by an improved distribution behaviour of the product in water. The particle size (diameter) of the solids or solid mixtures introduced into the mill as the material for fine milling is generally in the range of from 40 μm to 200 μm, preferably from 80 μm to 120 μm. After the completion of the fine milling operation, the particle size (diameter) of the finely milled solid is generally in the range of from 1 μm to 10 μm, preferably from 2 μm to 4 μm.

The process according to the invention can also be used for the homogeneous application of liquids to solids that are already in finely milled form. The present invention relates also to this specific embodiment of the process.

The amount of the liquid to be applied is in the range of from 0.001% by weight to 20% by weight, especially from 0.01% by weight to 10% by weight, preferably from 0.5% by weight to 5% by weight, based on the amount of the solid.

When the process according to the invention is carried out in mills in which the material for milling is moved by a milling gas stream or by a carrier gas stream, air is generally used as the milling or carrier gas. When processing explosive or readily oxidisable materials, however, it is also possible to use an inert gas, especially nitrogen.

As liquids that can be applied by means of the process according to the invention to finely milled solids there come into consideration, for example, liquid active ingredients, solutions of active ingredients, surface-active substances, such as non-ionic, anionic or cationic surfactants or detergents, flavourings and attractants, it being possible for surface-active substances, flavourings and attractants to be used, according to their physical properties, in the form of the substances per se or in the form of solutions.

The present invention relates also to a device for carrying out the process according to the invention, which device, as well as comprising means for introducing and for finely milling the material for milling and means for separating off and discharging the product, comprises a device which enables a finely divided liquid to be metered into the milling zone during the fine milling operation or simultaneously with the introduction of the material for milling. The device according to the invention is preferably based on a mill through which there flows a milling or carrier gas, which mill, as well as comprising a milling zone, a pipe for supplying the material for milling to the milling zone, a pipe for supplying the milling or carrier gas to the milling zone, a discharge pipe for the milling or carrier gas containing the finely milled solid charged with a liquid, and a separating device for separating the finely milled solid charged with a liquid from the milling or carrier gas, comprises a device which enables a finely divided liquid to be metered into the milling zone either by way of the carrier gas stream or directly.

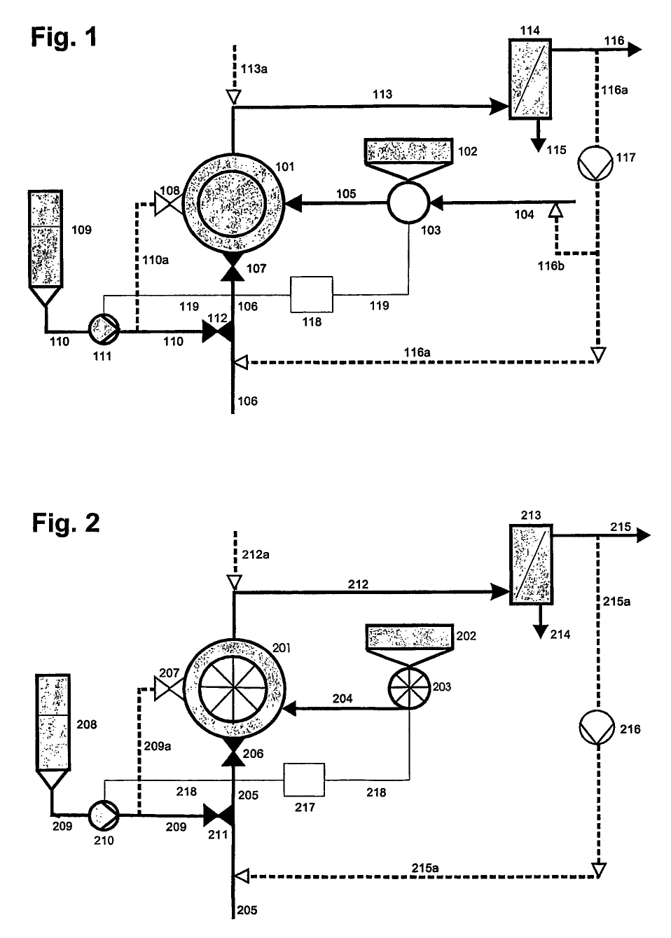

Examples of suitable devices for carrying out the process according to the invention are shown in the FIGS. 1 (FIG. 1) and 2 (FIG. 2).

FIG. 1 shows, in diagrammatic form, a gas-jet or fluidised-bed counter-jet mill which is provided according to the invention with a device for introducing a liquid. The continuous lines show the standard device. Several of the possible alternative embodiments are shown by broken lines.

FIG. 2 shows, in diagrammatic form, a mechanical mill which is provided according to the invention with a device for introducing a liquid. In FIG. 2 also, the continuous lines show the standard device, while several of the possible alternative embodiments are shown by broken lines.

The process according to the invention is explained hereinbelow with reference to the devices shown in the FIGS. 1 and 2.

FIG. 1

The material for milling is introduced into the gas-jet mill 101 from the storage container 102 via the feed device 103 and the pipe 105. The material for milling is fed into the gas-jet mill by means of a milling gas stream which is supplied through the pipe 104. At the same time, the liquid that is to be applied to the finely milled solid is introduced, from the storage container 109 via the pipe 110 and the metering pump 111, into the carrier gas supplied through the pipe 106. The liquid is either supplied via the nozzle 112, or is supplied directly (not shown in FIG. 1), to the carrier gas stream flowing at very high speed. The nozzle 112 is not absolutely necessary, because the liquid is atomised in the carrier gas stream flowing at very high speed even without the use of a nozzle (“Venturi effect”). The carrier gas/liquid mixture thus formed is introduced into the gas-jet mill 101 via the pipe 106 and the nozzle 107. The introduction of the carrier gas/liquid mixture into the gas-jet mill 101 can also take place using several nozzles simultaneously. The ratio of solid to liquid is controlled by means of the regulating unit 118, which is connected to the metering pump 111 and the feed device 103 by the control lines 119. The product/gas mixture leaving the gas-jet mill 101 is supplied via the pipe 113 to the separating device 114, from which the product separated from the gas is removed via the pipe 115. The gas separated from the product is discharged via the pipe 116. If desired, additional carrier gas can be supplied via the pipe 113a to the pipe 113 containing the product/gas mixture, in order to support the carriage of the product/gas mixture to the separating device 114. Instead of being introduced via the pipe 110 (not shown in FIG. 1) or the nozzle 112 into the carrier gas supplied through the pipe 106, the liquid can also be introduced directly into the gas-jet mill 101 via the pipe 110a and the liquid nozzle 108. Furthermore, it is possible, that the gas separated from the product is not discharged from the device via the pipe 116 but is returned via the pipe 116a and the compressor 117 into the pipe 106 for the carrier gas. This procedure is advisable especially when a gas other than air, e.g. nitrogen, is used. A portion of the gas returned through the pipe 116a can also be introduced via the pipe 116b into the pipe 104 and used as milling gas. The supply of fresh gas, which is necessary owing to losses of gas, can be effected via the pipe 104 and/or the pipe 106.

FIG. 2

The material for milling is introduced into the mechanical mill 201 from the storage container 202 via the feed device 203, for example a star wheel or a feed screw, and the pipe 204. At the same time, the liquid that is to be applied to the finely milled solid is introduced, from the storage container 208 via the pipe 209, the metering pump 210 and the nozzle 211, into the carrier gas supplied through the pipe 205. The carrier gas/liquid mixture thus formed is introduced into the mechanical mill 201 via the pipe 205 and the nozzle 206. The introduction of the carrier gas/liquid mixture into the mechanical mill 201 can also take place using several nozzles simultaneously. The ratio of solid to liquid is controlled by the regulating unit 217, which is connected to the feed device 203 and the metering pump 210 by the control lines 218. The product/gas mixture leaving the mechanical mill 201 is supplied via the pipe 212 to the separating device 213, from which the product separated from the gas is removed via the pipe 214. The gas separated from the product is discharged via the pipe 215. If desired, additional carrier gas can be supplied via the pipe 212a to the pipe 212 containing the product/gas mixture, in order to support the carriage of the product/gas mixture to the separating device 213. Instead of being introduced via the nozzle 211 into the carrier gas supplied through the pipe 205, the liquid can also be introduced directly into the mechanical mill 201 via the pipe 209a and the liquid nozzle 207. Furthermore, it is possible, that the gas separated from the product is not discharged from the device via the pipe 215 but is returned via the pipe 215a and the compressor 216 into the pipe 205 for the carrier gas. This procedure is advisable especially when a gas other than air, e.g. nitrogen, is used. The supply of fresh gas, which is necessary owing to losses of gas, can be effected via the pipe 205.

The process according to the invention for the production of finely milled solids charged with a liquid has, for example, the following advantages over the known process:
The process according to the invention constitutes a substantial simplification, because it enables the solid to be finely milled and the finely milled solid to be charged with a liquid in a single operation, while at least three operations are required with the known process.
The process according to the invention permits a homogeneous distribution of the liquid on the particles of the finely milled solid and accordingly a substantially better product quality.
It is possible using the process according to the invention for even very small amounts of highly viscous liquids to be applied homogeneously to the particles of the finely milled solid in a simple manner, which with the known process is possible only with a considerable outlay or is not possible at all.
The process according to the invention, especially when carried out in gas-jet mills or fluidised-bed counter-jet mills, offers an increased safety in the processing of combustible solids or mixtures of solids, because in gas-jet mills or fluidised-bed counter-jet mills, in contrast to the mixers used in accordance with the prior art, there are no mechanically moved machine parts which can act as sources of ignition.

The following Examples explain the present invention in greater detail. Neither these Examples nor the Examples shown in the FIGS. 1 and 2 constitute a limitation of the present invention.

### EXAMPLES

### Example 1

A water dispersible powder for slurry seed treatment (WS formulation), which comprises as active ingredient the insecticidal compound thiamethoxam in an amount of 70% by weight, is prepared. The solid raw material, consisting of the insecticidally active ingredient and customary auxiliaries and adjuvants, which has a mean particle size (diameter) of about 100 μm, is fed into a gas-jet mill according to FIG. 1. Air is used as the milling gas and the carrier gas. A highly viscous polyoxyethylene-polyoxypropylene copolymer liquid, heated to 50° C., having a dynamic viscosity of >4000 mPas, is added to the carrier gas stream in an amount of 4.5% by weight, based on the amount of the solid raw material fed in. The excess pressure is 6 bar in the milling gas stream and 6.5 bar in the carrier gas/liquid stream. In the resulting product, which exhibits improved handling properties, 50% of the milled particles have a particle size (diameter) of less than 3.7 μm and 90% of the milled particles have a particle size (diameter) of less than 11.1 μm, the liquid being homogeneously distributed on the particles of the finely milled solid.

The product thus obtainable exhibits a homogeneous distribution of the liquid on the particles of the finely milled solid, which cannot be obtained using the process of the prior art.

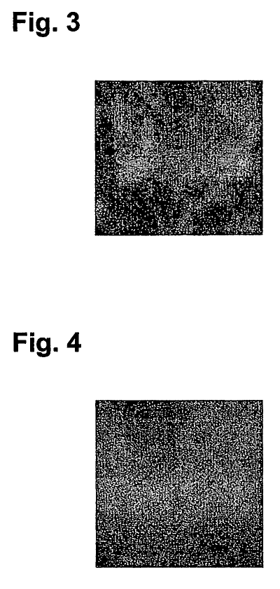

This difference in the homogeneities of the products is shown in the FIGS. 3 and 4, FIG. 3 illustrating the product quality achievable by the prior art process, i.e. by finely milling the solid, adding to the finely milled solid the liquid to be applied, mixing, further milling and mixing again, and FIG. 4 illustrating the homogeneity achievable by the process according to the invention.

Not only exhibits the product thus obtainable a substantially better quality, but the process for its preparation also constitutes, compared with the known process, a substantial simplification. At the same time, the risk of a powder explosion is markedly reduced, because according to the exemplified process there are no mechanically moved machine parts, which could come into contact with the product and act as sources of ignition.

### Example 2

In a manner analogous to that described in Example 1 the product obtainable according to the process of Example 1 can also be prepared using an inert milling gas, such as nitrogen or argon.

1. A process of applying a liquid to a finely milled solid, in which the liquid to be applied to a solid that is to be finely milled is introduced into the milling zone of a fine milling device during the milling operation or simultaneously with the introduction of the solid to be finely milled, and the fine milling is carried out in the presence of the finely divided liquid.

2. A process according to claim 1, in which there is used a fine milling device in which the material for milling is moved by a gas stream flowing through the milling zone.

3. A process according to claim 1, in which a gas-jet or fluidised-bed counter-jet mill is used.

4. A process according to claim 1, in which an impact mill is used.

5. A process according to claim 1, in which a hammer mill is used.

6. A process according to claim 1, in which a ready-formulated active ingredient mixture is used as the solid to be finely milled and charged with a liquid.

7. A process according to claim 1, in which a ready-formulated pesticide or a crop protection product is used as the material for milling.

8. A process according to claim 1, in which the particle size of the solid to be finely milled is in the range of from 40 μm to 200 μm.

9. A process according to claim 1, in which the particle size of the solid to be finely milled is in the range of from 80 μm to 120 μm.

10. A process according to claim 1, in which the liquid to be applied to the finely milled solid is a liquid active ingredient, the solution of an active ingredient, a surface-active substance, a flavouring or an attractant.

11. A process according to claim 1, in which the amount of liquid to be applied is in the range of from 0.01 to 10% by weight, based on solid to be finely milled.

12. A device for carrying out the process according to claim 1, which device, as well as comprising means for introducing and for finely milling the material to be milled and means for discharging the product, comprises a device which enables a finely divided liquid to be metered into the milling zone during the fine milling operation or simultaneously with the introduction of the material for milling.

13. A device according to claim 12, through which a milling or carrier gas flows and which, as well as comprising a milling zone, a pipe for supplying the material for milling to the milling zone, a pipe for supplying the milling or carrier gas to the milling zone, a discharge pipe for the milling or carrier gas containing the finely milled solid charged with a liquid, and a separating device for separating the finely milled solid charged with a liquid from the milling or carrier gas, comprises a device which enables a finely divided liquid either to be metered into the milling zone by way of the milling or carrier gas stream or to be metered directly into the milling zone.

14. A device according to claim 12, comprising a gas-jet mill 101, a storage container 102 for the material for milling, a feed device 103 for the material for milling, which feed device 103 is provided with a supply pipe 104 for carrier gas, a supply pipe 105 for introducing the material for milling into the gas-jet mill 101, a supply pipe 106 for the milling gas, a discharge pipe 113 for the milling gas containing the finely milled solid charged with a liquid, a device 114 for separating the finely milled solid charged with a liquid from the milling gas, a pipe 115 for removing the finely milled solid charged with a liquid, and a discharge pipe 116 for the milling gas freed of the solid, which device is provided with a storage container 109 for the liquid to be applied, a pipe 110 for supplying the liquid to be applied into the milling gas stream 106, a liquid pump 111, arranged in the supply pipe 110, for metering the liquid either into the milling gas stream 106 or via pipe 110a and a nozzle 108 into the gas-jet mill 101, and a regulating device 118, which is connected to the pump 111 and the feed device 103 via a control line 119, for controlling the ratio of solid to be finely milled to liquid to be applied.

15. A device according to claim 14, which, instead of being provided with a pipe 116 for discharging the milling gas freed of the finely milled solid, is provided with a pipe 116a for returning the milling gas freed of the solid into the supply pipe 106 and with a compressor 117 arranged in the pipe 116a.

16. A device according to claim 12, comprising a mechanical mill 201, a storage container 202 for the material for milling, a feed device 203 for the material for milling, a supply pipe 204 for introducing the material for milling into the mechanical mill 201, a supply pipe 205 for the carrier gas, a discharge pipe 212 for the carrier gas containing the finely milled solid charged with a liquid, a device 213 for separating the finely milled solid charged with a liquid from the carrier gas, a pipe 214 for removing the finely milled solid charged with a liquid, and a discharge pipe 215 for the carrier gas freed of the solid, which device is provided with a storage container 208 for the liquid to be applied, a supply pipe 209 for the liquid to be applied, a liquid pump 210, arranged in the supply pipe 209, for metering the liquid either into the carrier gas stream 205 or via pipe 209a and a nozzle 207 into the mechanical mill 201, and a regulating device 217, connected to the pump 210 and the feed device 203 via a control line 218, for controlling the ratio of solid to be finely milled to liquid to be applied thereto.

17. A device according to claim 16, which, instead of being provided with a pipe 215 for discharging the milling gas freed of the finely milled solid, is provided with a pipe 215a for returning the milling gas freed of the solid into the supply pipe 205 and with a compressor 216 arranged in the pipe 215a.

18. A device according to claim 14, in which the liquid container 109 or 208, the pipe 110 or 209 and the pump 111 or 210 is provided with a heating device.
